(19) United States
(12) Patent Application Publication
(10) Pub. No.: US 2009/0031282 A1
(43) Pub. Date: Jan. 29, 2009

(54) PROGRAMMING METHOD COMBINING STATIC INTERACTION APPROACH AND DYNAMIC INTERACTION APPROACH

(75) Inventor: Chien-Ho KO, Taipei (TW)

Correspondence Address: Muncy, Geissler, Olds & Lowe, PLLC, P.O. BOX 1364, FAIRFAX, VA, 22038-1364, US

(73) Assignee: DA-YEH UNIVERSITY

(21) Appl. No.: 12/049,790

(22) Filed: Mar. 17, 2008

(30) Foreign Application Priority Data
Jul. 24, 2007 (TW) 96126992

(51) Int. Cl. G06F 9/44

(52) U.S. Cl. 717/106

(57) ABSTRACT

A programming method combining a static interaction approach and a dynamic interaction approach is disclosed. A static interaction procedure shows the executive result of program on a display device. A dynamic interaction procedure employs a programmable moving device. The program, written by using the same programming technique with static interaction approach, is transferred from PC to the programmable mobile device to demonstrate the executive result of the program.

### RELATED APPLICATIONS

The application claims priority to Taiwan Application Serial Number 96126992, filed Jul. 24, 2007, which is herein incorporated by reference.

### BACKGROUND

1. Field of Invention

The present invention relates to a method of designing computer programs. More particularly, the present invention relates to a method with combining a static interaction approach and a dynamic interaction approach in writing program languages.

2. Description of Related Art

Computer programs are one of the important components in IT (Information Technology) industry development. Although many schools and institutions provide a variety of courses to teach people how to write computer programs, the training or learning effect does not achieve expectancy because of the complexity of programming and the conventional methods of teaching are not attractive to learners.

In addition, programming is an important course for training logical thinking ability. Traditional teaching methods of programming is simply to introduce the content such as syntax, operators etc. Then, let the learners know and learn how to write programs in advance, practice writing programs, and show the result of programs on a display. However, the learners cannot feel that they practically and physically attend the learning procedure of writing programs through the conventional teaching method. Moreover, exemplary programs in classes are typically related to solve digitizing problems like trading operations, grade calculation and so forth. Beginners would feel these programming tasks are monotonous and difficult to understand, and then lose interest in learning programming. Thus, the effect of learning programming for beginners would be lowered.

### SUMMARY

An object of the present invention is to provide a programming method combining a static interaction approach and a dynamic interaction approach, and the programming method uses a common digitizing problem and a robot control problem to explain how to write respectively a program for solving the aforementioned problems with a common algorithm.

The programming method in accordance with the present invention decides on a programming algorithm to learn. A plurality of unsolved problems including a static unsolved problem and a dynamic unsolved problem are provided according to the programming algorithm. A first executable program is written to solve the static unsolved problem using the programming algorithm so as to show a result of the first executable program execution on a display device so that a programmer could observe the result of the first executable program execution, immediately.

Likewise, a second executable program is written to solve the dynamic unsolved problem using the programming algorithm which is the same as the static unsolved problem. The second executable program is transmitted to a programmable mobile device to control the programmable mobile device moving with the second executable program, so that the programmer could observe the result of the second executable program execution.

In an embodiment, the programming method further includes a step of program verification. One of the aforementioned unsolved problems is selected for the programmer to write a program to solve within a given time interval. Then, the result of the program execution is compared with the unsolved problem to verify the correctness of the program so as to judge the programming performance.

The manner of using a common digitizing problem (i.e. a static interaction approach) and a robot control problem (i.e. a dynamic interaction approach) simultaneously is a good way to excite the programmers' interest and creation in programming.

### BRIEF DESCRIPTION OF THE DRAWINGS

These and other features, aspects, and advantages of the present invention will become better understood with regard to the following description, appended claims, and accompanying drawings where:

FIG. 1 is a block diagram of an embodiment of a system of combining a static interaction approach and a dynamic interaction approach;

FIG. 2 is a flowchart of a programming method combining a static interaction approach and a dynamic interaction approach in accordance with the present invention;

FIG. 3 is a schematic view of a programmable mobile device in accordance with the present invention;

FIG. 4a is a schematic view of a programmable mobile device in FIG. 3 moving forward;

FIG. 4b is a schematic view of a programmable mobile device in FIG. 3 moving in reverse;

FIG. 4c is a schematic view of a programmable mobile device in FIG. 3 turning left; and

FIG. 4d is a schematic view of a programmable mobile device in FIG. 3 turning right;

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

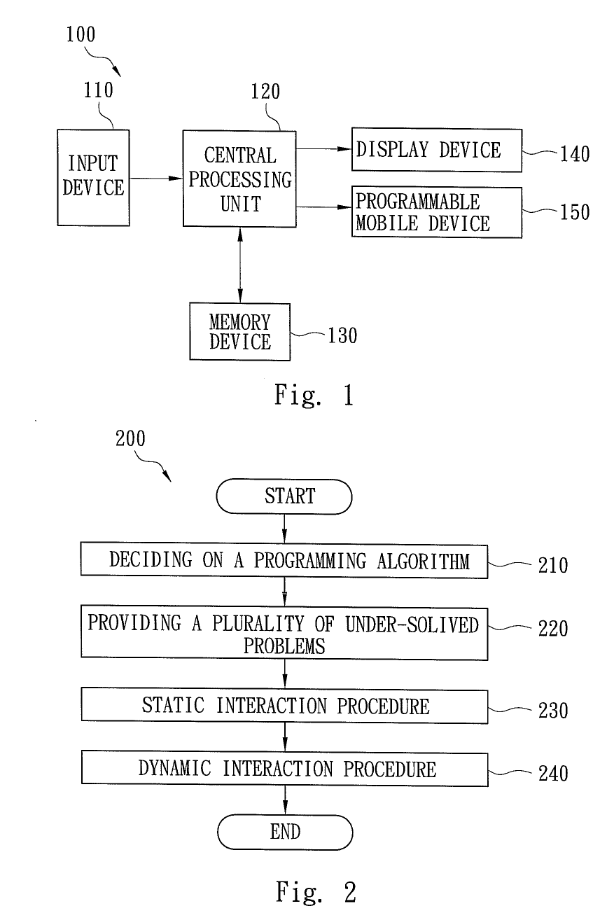

Refer to FIG. 1. A system 100 for a programming method includes an input device 110, a central processing unit 120, a memory device 130, a display device 140 and a programmable mobile device 150. The input device 110 is a medium for inputting data, for instance, programs, for the processes of the central processing unit 120, and the data is stored in the memory device 130. After the data is executed, the result is selectively output to the display device 140 or the programmable mobile device 150.

In the present embodiment, the input device 110 is a keyboard to input the program into the central processing unit 120. The program is stored in the memory device 130. The display device 150 is a display panel to show the procedure of the program execution and the result of the program execution. The programmable mobile device 160 is an anthropomorphous machine (so-called robot) with driving motors. The controls of the motion of the programmable mobile device 160 are based on the written program. Therefore, the programmer could observe the result of the program execution from the display device 150 or the programmable mobile device 160, which are different types to show.

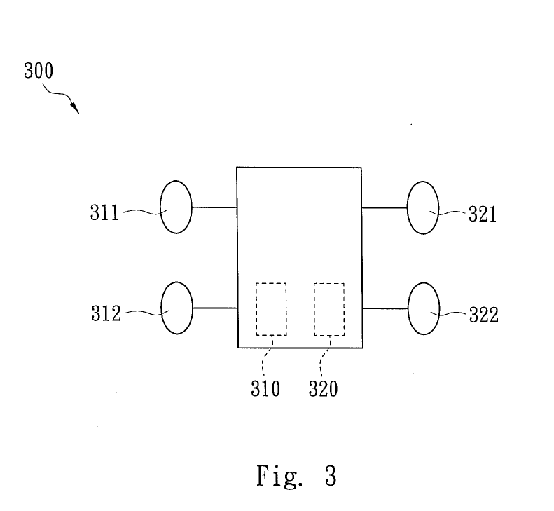

Refer to FIG. 2. According to a preferred embodiment in accordance with the present invention, the method 200 uses simultaneously a common digitizing problem (i.e. a static interaction approach) and a robot-controlled problem (i.e. a dynamic interaction approach) in the program design. The method 200 includes the steps as follows.

Step 1 (denoted by numeral 210) decides on a programming algorithm to learn, which provides a method for teaching a learner (i.e. a beginner programmer) how to write a program and build up the programming concepts in the beginning. The programming algorithm may include a loop, a selection, an object-oriented, a class, a overloading, an inheritance, an encapsulation, and more.

Step 2 (denoted by numeral 220) provides a plurality of unsolved problems. According to the decided programming algorithm in step 1, a plurality of unsolved problems including a static unsolved problem and a dynamic unsolved problem are provided. Those unsolved problems used in the whole course are consistent to all learners. If the learner finishes writing the program to solve those unsolved problems with the given programming algorithm, the program function and the programming algorithm may be reassigned with a new programming algorithm to learn. Then, the learner continues to solve the same unsolved problems through using the reassigned programming algorithm to achieve the program function. In the present embodiment, the static unsolved problem is a common digitizing problem, and more particularly that relates to a problem of drawing a rectangle and a triangle on the display panel. The dynamic unsolved problem is a robot-controlled problem and more particularly that relates to a problem of controlling a robot vehicle to move forward, in reverse, turnaround and stop.

Step 3 (denoted by numeral 230) performs a static interaction procedure. A first executable program is written using the programming algorithm according to the static unsolved problem, and the result of the first executable program execution is shown on a display device 150.

Step 4 (denoted by numeral 240) performs a dynamic interaction procedure. A second executable program is written using the programming algorithm identical with the programming algorithm used in the first executable program according to the dynamic unsolved problem. Then, the second executable program is transmitted to a programmable mobile device (i.e. the vehicle) to control the programmable mobile device moving based on the second executable program. Thus, the learner could observe the result of the second executable program execution.

In the present embodiment, the step 3 (denoted by numeral 230) is a static interaction procedure, wherein the unsolved problem is the problem of drawing a rectangle and a triangle on the display panel. Firstly, the first executable program is written by a traditional modular programming technique to solve the problem of drawing a rectangle and a triangle.

In the present embodiment, the first executable program calls initially the preprocessor to control the head file, and then declaring functions, writing main program and subroutine are proceeded. Then the first executable program is compiled and debugged. Finally, the first executable program is run, and the result is shown on a display device to let the learner observe.

The following is the result of the first executable program execution displayed on the screen, which includes: The hint messages are “THIS PROGRAM DRAWS A RECTANGLE OR A TRIANGLE ON THE SCREEN”, “Enter 1 to draw a rectangle” and “Enter 2 to draw a triangle:.” When the input signal is “1” by typing numeral “1” on the input device 110, a rectangular figure is shown on the display device 140. When the input signal is “2” by typing numeral “2” on the input device 110, a triangular figure is shown on the display device 140. After each time the figure is shown on the display device 140, there is another hint message, which is “Do you want to continue? (y/n):”, shown on the display device 140. When the input signal is “y”, the first executable program is allowed to continue running. Oppositely, the input signal is “n”, the first executable program is terminated.

According to another embodiment in accordance with the present invention, another programming algorithm is provided to solve the problem of drawing a rectangle and a triangle, which is an object-oriented programming technique. First, the head file is inputted, and a shape class, a triangle class and a rectangle class are defined separately. Then, a main program is written to make the display device show a hint message being a requirement for inputting variables including a length A and a length B.

One index variable is defined as one example responding to one class separately which includes a “shape” class, a “triangle” class and a “rectangle” class. Then the letter word length and the precision are defined as 5-letter word and 3 digits separately. The triangular figure and the rectangular figure are shown on the display device by a dynamic link. And then the area of the triangle and the rectangle are calculated respectively depending on the length A and the length B. For instance, the length A is 11.234 and the length B is 8.346. The area of the triangle and the rectangle, which are calculated by the program, are 46.9 and 93.8, respectively.

In the present embodiment, the step 4 (denoted by numeral 240) is a dynamic interaction procedure, wherein the unsolved problem is the problem of controlling the robot moving forward, in reverse, turnaround and stop. The second executable program is written by a traditional modular programming technique to solve the problem of controlling the robot moving forward, in reverse, turnaround and stop.

First, the second executable program calls the preprocessor to control the needed head file, and then defining variables and declaring functions. In addition, a main program and a subroutine start to be written. In the main program, a name of a sensor is set, and then the sensor is started, and using a “for” loop to run four functions sequentially, which are the function of the robot moving forward, back, turning left and right, depends on each judging condition individually.

The main program includes setting an initial value and a start condition. In the present embodiment, the initial value is 4 and is automatically added one after each time the main program is run. Each judging condition of four functions is separately explained as below. The initial value divided by a default value produces a remainder. If the remainder equals zero, the function of moving forward is run. If the remainder equals 1, the function of moving in reverse is run. If the remainder equals 2, the function of turning left is run. If the remainder equals 3, the function of turning right is run. The main program still includes a stop function, which makes the robot stop working. In the present embodiment, the default value is 4.

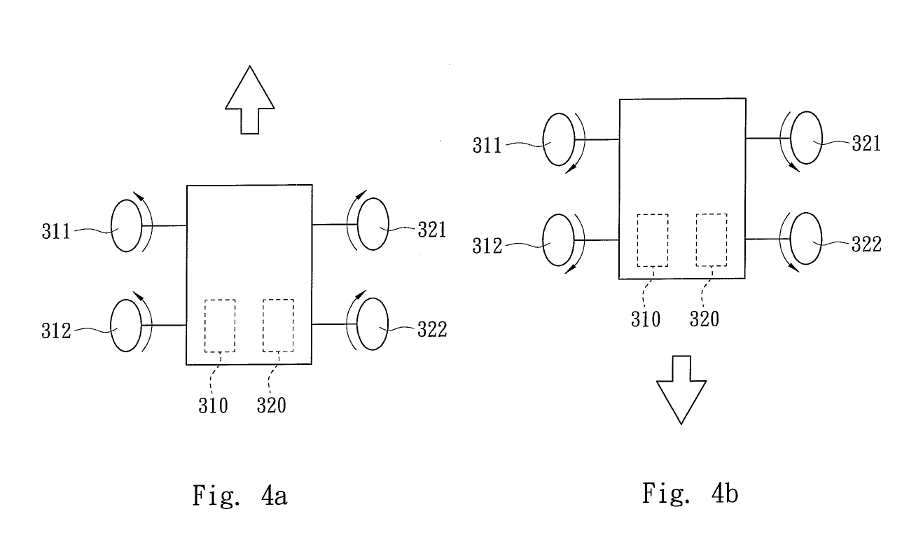

Refer to FIG. 3. A programmable mobile device 300 includes a first motor 310 and a second motor 320. The first motor 310 drives a first wheel 311 and a second wheel 312 simultaneously. The second motor 320 drives a third wheel 321 and a forth wheel 322 simultaneously.

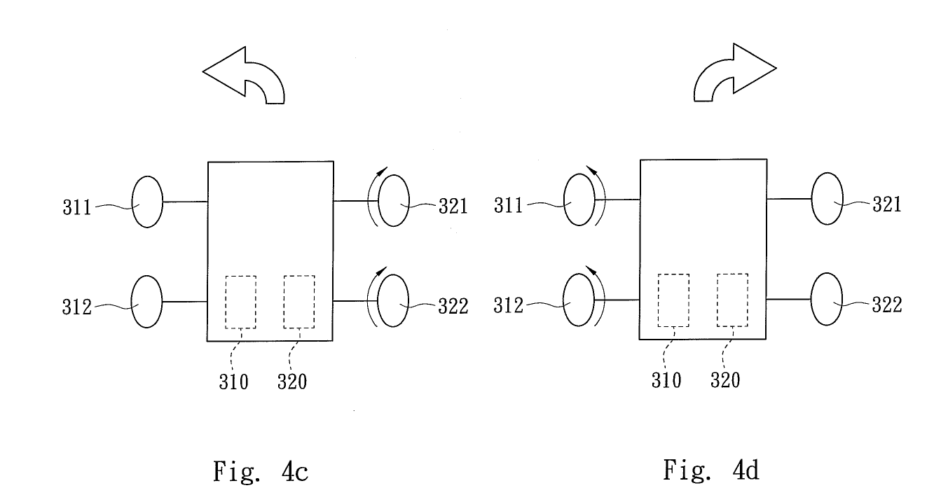

Refer to FIG. 4a. A subroutine of a moving forward function is applied to drive the first motor 310 and the second motor 320, and makes them rotate forward in the same direction. Therefore, the programmable mobile device 300 could go forward as denoted by the arrow shown in FIG. 4a.

Refer to FIG. 4b. A subroutine of a moving in reverse function is applied to drive the first motor 310 and the second motor 320, and make them rotate in a reverse direction and in the same direction to each other. Therefore, the programmable mobile device 300 could go back as denoted by the arrow shown in FIG. 4b.

Refer to FIG. 4c. A subroutine of a turning left function is applied to drive the second motor 320, and make it rotate forward. Only the third wheel 321 and the forth wheel 322 are rotated simultaneously in the same direction so the programmable mobile device 300 could turn left as denoted by the arrow shown in FIG. 4c.

Refer to FIG. 4d. A subroutine of a turning left function is applied to drive the first motor 310, and make it rotate forward. Only the first wheel 311 and the second wheel 312 are rotated simultaneously in the same direction so the programmable mobile device 300 could turn right as denoted by the arrow shown in FIG. 4d.

After the second executable program has been written, it is compiled and debugged. Then the second executable program is run and is transmitted to the programmable mobile device 300 to control the programmable mobile device moving with the second executable program. Therefore, the learner could observe the executive process and the result of the second executable program. The programmable mobile device 300 moves forward, in reverse, turnaround and stop according to the written second executable program.

In another embodiment in accordance with the present invention, another programming algorithm is provided, which adopts object-oriented programming to solve the problem of controlling the robot to move forward, in reverse, turnaround and stop. Firstly, the head file is controlled and includes a head file relative to the light sensor and a head file relative to a motor. Defining the classes, which includes a given “turn left” class, a given “turn left in curve” class and a given “turn left pivot” class.

A main program is written, wherein every one index variable is defined as one example separately responding to a “Turn_left” class, a “Turn_left_in_curve” class and a “Turn_left_in pivot” class. Each function of each class is run through the dynamic link. After the program is compiled and debugged, the program is transmitted to the programmable mobile device. The programmable mobile device functions, for instance, turning left and rotation 360 degrees, depending on the program

In the present embodiment, the programmable mobile device is a LEGO Mindstorms Robot in the dynamic interaction procedure. The learner has to use C language or C++ object-oriented programming language to write programs, which is applied to control the programmable mobile device moving forward, in reverse, turnaround and stop.

In another embodiment in accordance with the present invention, the method further includes a step of program verification after step 4. One of the aforementioned unsolved problems is decided to let the programmer write a program to solve the unsolved problem within a given time interval. And then the result of program execution is compared with the unsolved problem to verify whether the program is correct or not so as to judge the programming performance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A programming method combining a static interaction approach and a dynamic interaction approach, and the programming method comprising:
(a) deciding on a programming algorithm to learn;
(b) providing a plurality of unsolved problems including a static unsolved problem and a dynamic unsolved problem according to the programming algorithm;
(c) writing a first executable program solving the static unsolved problem using the programming algorithm, and showing a result of the first executable program execution on a display device to provide an observation of the result of the first executable program execution for a programmer; and
(d) writing a second executable program solving the dynamic unsolved problem using the programming algorithm, and transmitting the second executable program to a programmable mobile device to control movements of the programmable mobile device to produce an execution result to provide an observation of the result of the second executable program execution for the programmer.

2. The programming method as claimed in claim 1, wherein after the step (d) further includes
(e) a step of program verification comprising
deciding one of the unsolved problems for the programmer to write a program solving the decided unsolved problem within a given time interval; and
comparing an execution result of the program to the decided unsolved problem to verify the correctness of the program.

3. The programming method as claimed in claim 2, wherein the decided unsolved problem is a static unsolved problem.

4. The programming method as claimed in claim 2, wherein the decided unsolved problem is a dynamic unsolved problem.

5. The programming method as claimed in claim 3, wherein the static unsolved problem is a problem of drawing a rectangle and a triangle on the display device.

6. The programming method as claimed in claim 4 wherein the dynamic unsolved problem is a problem of controlling the programmable mobile device to move forward.

7. The programming method as claimed in claim 4 wherein the dynamic unsolved problem is a problem of controlling the programmable mobile device to move in reverse.

8. The programming method as claimed in claim 4 wherein the dynamic unsolved problem is a problem of controlling the programmable mobile device to turnaround.

9. The programming method as claimed in claim 4 wherein the dynamic unsolved problem is a problem of controlling the programmable mobile device to stop.

10. The programming method as claimed in claim 4 wherein the dynamic unsolved problem is a problem of controlling the programmable mobile device to move selectively forward, in reverse, turnaround and stop.

11. The programming method as claimed in claim 1, wherein the programming algorithm is at lest one of a loop algorithm, a selection algorithm, an object-oriented algorithm, a class algorithm, an overloading algorithm, an inheritance algorithm, and an encapsulation algorithm.
